(19) United States
(12) Patent Application Publication
(10) Pub. No.: US 2022/0372399 A1
(43) Pub. Date: Nov. 24, 2022

(54) DETERGENT COMPOSITIONS

(71) Applicant: Conopco, Inc., d/b/a UNILEVER, Englewood Cliffs, NJ (US)

(72) Inventors: Mrinalini Jayant Puranik, Bangalore (IN); Katherine Mary Thompson, Bebington, Wirral (GB)

(73) Assignee: Conopco, Inc., d/b/a UNILEVER, Englewood Cliffs, NJ (US)

(21) Appl. No.: 17/761,219

(22) PCT Filed: Sep. 17, 2020
(86) PCT No.: PCT/EP2020/076057

§ 371 Date: Mar. 17, 2022

(30) Foreign Application Priority Data
Sep. 19, 2019 (EP) 19198463.2

(51) Int. Cl. C11D 1/83; C11D 11/00; C11D 3/00; C11D 3/33; C11D 3/37; C11D 3/386; C11D 3/395

(52) U.S. Cl. CPC C11D 1/83; C11D 11/0017; C11D 3/0036; C11D 3/33; C11D 3/3788; C11D 3/38636; C11D 3/38627; C11D 3/38618; C11D 3/3953; C11D 1/72

(57) ABSTRACT

The invention provides a detergent composition for the non-oxidative laundering of fabric stains, the composition comprising: (a) from 0.1 to 10% (by weight based on the total weight of the composition) of ethylenediamine-N,N′-bis-(2-hydroxyphenyl) acetic acid (EDDHA) and/or salts thereof, and (b) from 3 to 80% (by weight based on the total weight of the composition) of one or more detersive surfactants.

### FIELD OF THE INVENTION

The present invention relates to detergent compositions for the non-oxidative laundering of fabric stains.

### BACKGROUND AND PRIOR ART

Significant efforts have been invested in recent years towards improving the washing performance of laundry detergents at low temperatures. Lifecycle studies show that the largest environmental impact of the laundry process is during the use phase, especially when the water of the main wash is heated. Consequently, a temperature reduction is a pivotal driver to improve the overall sustainability profile of the laundry process. Washing at cooler temperatures is also advisable for care of coloured and/or delicate fabrics.

At the same time, environmental regulations are becoming more stringent in many countries, making it necessary for formulators to produce detergents that reduce potential negative impacts on wastewater and water ways, and reduce greenhouse gas emissions.

As consumers move to lower wash temperatures and seek products with improved environmental credentials, the satisfactory removal of stains presents a continuing challenge. Stains are usually caused by molecules of coloured substances deposited on or in fibres or in residual soil. Highly coloured stains are particularly difficult to remove. They often originate from polyphenolic compounds, such as the natural flavonoids found in tea and red wine.

Oxidizing bleaches such as peroxygen compounds have been used for the oxidative degradation and decolorisation of highly coloured stains. However, peroxygen compounds have reduced efficacy at lower temperatures and cannot generally be incorporated into liquid laundry detergents without storage stability problems. Oxidizing bleaches may also be unsuitable for prolonged or intensive use on coloured or delicate fabrics.

Transition metal sequestrants have been used to improve stain removal at low temperatures. However, the most effective of these tend to be phosphorus-based compounds.

It is an object of the present invention to solve the above problem.

### SUMMARY OF THE INVENTION

The present invention provides a detergent composition for the non-oxidative laundering of fabric stains, the composition comprising:

(a) from 0.1 to 4% (by weight based on the total weight of the composition) of ethylenediamine-N,N′-bis-(2-hydroxyphenylacetic acid) (EDDHA) and/or salts thereof, and

(b) from 3 to 80% (by weight based on the total weight of the composition) of one or more detersive surfactants.

The invention also provides a method for the non-oxidative laundering of fabric stains, comprising diluting a dose of the detergent composition defined above to obtain a wash liquor, and washing the stained fabric with the wash liquor so formed.

### DETAILED DESCRIPTION AND PREFERRED EMBODIMENTS

Ethylenediamine-N,N′-bis-(2-hydroxyphenyl) acetic acid (EDDHA) may be represented by the following general formula (I):

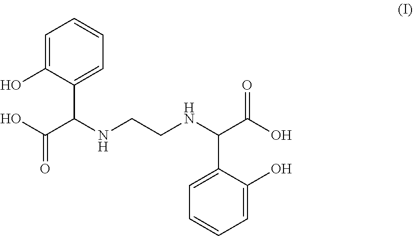

The term “salts thereof” denotes that one or more of the salifiable functional groups in general formula (I), such as the carboxylic acid functional groups, is (are) salified.

Such salts include, for example, alkali metal, alkaline earth metal, or ammonium salts. Also mixed salts containing different cations can be used. Sodium and/or potassium salts are preferred.

Mixtures of any of the above described materials may also be used.

The total amount of EDDHA and/or salts thereof (a) in a composition of the invention typically ranges from about 0.2 to 7.5%, preferably from 0.3 to 6%, more preferably from 0.4 to 5% and most preferably from 0.5 to 2.5% (by weight based on the total weight of the composition).

Detergent Compositions

The term “detergent composition” in the context of this invention denotes formulated compositions intended for and capable of wetting and cleaning domestic laundry such as clothing, linens and other household textiles. The term “linen” is often used to describe certain types of laundry items including bed sheets, pillow cases, towels, tablecloths, table napkins and uniforms. Textiles can include woven fabrics, non-woven fabrics, and knitted fabrics; and can include natural or synthetic fibres such as silk fibres, linen fibres, cotton fibres, polyester fibres, polyamide fibres such as nylon, acrylic fibres, acetate fibres, and blends thereof including cotton and polyester blends.

Examples of detergent compositions include heavy-duty detergents for use in the wash cycle of automatic washing machines, as well as fine wash and colour care detergents such as those suitable for washing delicate garments (e.g. those made of silk or wool) either by hand or in the wash cycle of automatic washing machines.

The composition of the invention comprises inter alia from 3 to 80% (by weight based on the total weight of the composition) of one or more detersive surfactants (b).

The term “detersive surfactant” in the context of this invention denotes a surfactant which provides a detersive (i.e. cleaning) effect to laundry treated as part of a domestic laundering process.

The choice of detersive surfactant, and the amount present, will depend on the intended use of the detergent composition. For example, different surfactant systems may be chosen for hand-washing products and for products intended for use in different types of automatic washing machine. The total amount of detersive surfactant present will also depend on the intended end use. In compositions for machine washing of fabrics, an amount of from 5 to 40%, such as 15 to 35% (by weight based on the total weight of the composition) is generally appropriate. Higher levels may be used in compositions for washing fabrics by hand, such as up to 60% (by weight based on the total weight of the composition.

Preferred detersive surfactants may be selected from non-soap anionic surfactants, nonionic surfactants and mixtures thereof.

Non-soap anionic surfactants are principally used to facilitate particulate soil removal. Non-soap anionic surfactants for use in the invention are typically salts of organic sulfates and sulfonates having alkyl radicals containing from about 8 to about 22 carbon atoms, the term “alkyl” being used to include the alkyl portion of higher acyl radicals. Examples of such materials include alkyl sulfates, alkyl ether sulfates, alkaryl sulfonates, alpha-olefin sulfonates and mixtures thereof. The alkyl radicals preferably contain from 10 to 18 carbon atoms and may be unsaturated. The alkyl ether sulfates may contain from one to ten ethylene oxide or propylene oxide units per molecule, and preferably contain one to three ethylene oxide units per molecule. The counterion for anionic surfactants is generally an alkali metal such as sodium or potassium; or an ammoniacal counterion such as monoethanolamine, (MEA) diethanolamine (DEA) or triethanolamine (TEA). Mixtures of such counterions may also be employed.

A preferred class of non-soap anionic surfactant for use in the invention includes alkylbenzene sulfonates, particularly linear alkylbenzene sulfonates (LAS) with an alkyl chain length of from 10 to 18 carbon atoms. Commercial LAS is a mixture of closely related isomers and homologues alkyl chain homologues, each containing an aromatic ring sulfonated at the “para” position and attached to a linear alkyl chain at any position except the terminal carbons. The linear alkyl chain typically has a chain length of from 11 to 15 carbon atoms, with the predominant materials having a chain length of about C12. Each alkyl chain homologue consists of a mixture of all the possible sulfophenyl isomers except for the 1-phenyl isomer. LAS is normally formulated into compositions in acid (i.e. HLAS) form and then at least partially neutralized in-situ.

Also suitable are alkyl ether sulfates having a straight or branched chain alkyl group having 10 to 18, more preferably 12 to 14 carbon atoms and containing an average of 1 to 3EO units per molecule. A preferred example is sodium lauryl ether sulfate (SLES) in which the predominantly C12 lauryl alkyl group has been ethoxylated with an average of 3EO units per molecule.

Some alkyl sulfate surfactant (PAS) may be used, such as non-ethoxylated primary and secondary alkyl sulfates with an alkyl chain length of from 10 to 18.

Mixtures of any of the above described materials may also be used. A preferred mixture of non-soap anionic surfactants for use in the invention comprises linear alkylbenzene sulfonate (preferably C₁₁ to C₁₅ linear alkyl benzene sulfonate) and sodium lauryl ether sulfate (preferably C₁₀ to C₁₈ alkyl sulfate ethoxylated with an average of 1 to 3 EO).

In a detergent composition according to the invention, the total level of non-soap anionic surfactant may suitably range from 5 to 30% (by weight based on the total weight of the composition).

Nonionic surfactants may provide enhanced performance for removing very hydrophobic oily soil and for cleaning hydrophobic polyester and polyester/cotton blend fabrics. Nonionic surfactants for use in the invention are typically polyoxyalkylene compounds, i.e. the reaction product of alkylene oxides (such as ethylene oxide or propylene oxide or mixtures thereof) with starter molecules having a hydrophobic group and a reactive hydrogen atom which is reactive with the alkylene oxide. Such starter molecules include alcohols, acids, amides or alkyl phenols. Where the starter molecule is an alcohol, the reaction product is known as an alcohol alkoxylate. The polyoxyalkylene compounds can have a variety of block and heteric (random) structures. For example, they can comprise a single block of alkylene oxide, or they can be diblock alkoxylates or triblock alkoxylates.

Within the block structures, the blocks can be all ethylene oxide or all propylene oxide, or the blocks can contain a heteric mixture of alkylene oxides. Examples of such materials include aliphatic alcohol ethoxylates such as C₈ to C₁₈ primary or secondary linear or branched alcohol ethoxylates with an average of from 2 to 40 moles of ethylene oxide per mole of alcohol.

A preferred class of nonionic surfactant for use in the invention includes aliphatic C₈ to 018, more preferably 012 to 015 primary linear alcohol ethoxylates with an average of from 3 to 20, more preferably from 5 to 10 moles of ethylene oxide per mole of alcohol.

Mixtures of any of the above described materials may also be used.

In a detergent composition according to the invention, the total level of nonionic surfactant may suitably range from 0 to 25% (by weight based on the total weight of the composition).

A detergent composition of the invention may contain one or more cosurfactants (such as amphoteric (zwitterionic) and/or cationic surfactants) in addition to the non-soap anionic and/or nonionic detersive surfactants described above.

Specific cationic surfactants include C8 to C18 alkyl dimethyl ammonium halides and derivatives thereof in which one or two hydroxyethyl groups replace one or two of the methyl groups, and mixtures thereof. Cationic surfactant, when included, may be present in an amount ranging from 0.1 to 5% (by weight based on the total weight of the composition).

Specific amphoteric (zwitterionic) surfactants include alkyl amine oxides, alkyl betaines, alkyl amidopropyl betaines, alkyl sulfobetaines (sultaines), alkyl glycinates, alkyl carboxyglycinates, alkyl amphoacetates, alkyl amphopropionates, alkylamphoglycinates, alkyl amidopropyl hydroxysultaines, acyl taurates and acyl glutamates, having alkyl radicals containing from about 8 to about 22 carbon atoms, the term “alkyl” being used to include the alkyl portion of higher acyl radicals. Amphoteric (zwitterionic) surfactant, when included, may be present in an amount ranging from 0.1 to 5% (by weight based on the total weight of the composition).

A detergent composition according to the invention may suitably be in liquid or particulate form, or a mixture thereof.

The term “particulate” in the context of this invention denotes free-flowing or compacted solid forms such as powders, granules, pellets, flakes, bars, briquettes or tablets.

One preferred form for a particulate detergent composition according to the invention is a free-flowing powdered solid, with a loose (unpackaged) bulk density generally ranging from about 200 g/I to about 1,300 g/I, preferably from about 400 g/I to about 1,000 g/I, more preferably from about 500 g/I to about 900 g/I.

The detergent composition according to the invention is most preferably in liquid form.

The term “liquid” in the context of this invention denotes that a continuous phase or predominant part of the composition is liquid, and that the composition is flowable at 15° C. and above. Accordingly, the term “liquid” may encompass emulsions, suspensions, and compositions having flowable yet stiffer consistency, known as gels or pastes. The viscosity of the composition may suitably range from about 200 to about 10,000 mPa·s at 25° C. at a shear rate of 21 sec⁻¹. This shear rate is the shear rate that is usually exerted on the liquid when poured from a bottle. Pourable liquid compositions generally have a viscosity of from 200 to 2,500 mPa·s, preferably from 200 to 1500 mPa·s.

Liquid compositions which are pourable gels generally have a viscosity of from 1,500 mPa·s to 6,000 mPa·s, preferably from 1,500 mPa·s to 2,000 mPa·s.

A liquid detergent composition according to the invention may generally comprise from 5 to 95%, preferably from 10 to 90%, more preferably from 15 to 85% water (by weight based on the total weight of the composition). The composition may also incorporate non-aqueous carriers such as hydrotropes, co-solvents and phase stabilizers. Such materials are typically low molecular weight, water-soluble or water-miscible organic liquids such as C1 to C5 monohydric alcohols (such as ethanol and n- or i-propanol); C2 to C6 diols (such as monopropylene glycol and dipropylene glycol); C3 to C9 triols (such as glycerol); polyethylene glycols having a weight average molecular weight (M_{w}) ranging from about 200 to 600; C1 to C3 alkanolamines such as mono-, di- and triethanolamines; and alkyl aryl sulfonates having up to 3 carbon atoms in the lower alkyl group (such as the sodium and potassium xylene, toluene, ethylbenzene and isopropyl benzene (cumene) sulfonates).

Mixtures of any of the above described materials may also be used.

Non-aqueous carriers, when included in a liquid detergent composition according to the invention, may be present in an amount ranging from 0.1 to 20%, preferably from 1 to 15%, and more preferably from 3 to 12% (by weight based on the total weight of the composition).

Builders

A detergent composition according to the invention may contain one or more builders. Builders enhance or maintain the cleaning efficiency of the surfactant, primarily by reducing water hardness. This is done either by sequestration or chelation (holding hardness minerals in solution), by precipitation (forming an insoluble substance), or by ion exchange (trading electrically charged particles).

Builders for use in the invention can be of the organic or inorganic type, or a mixture thereof. Non-phosphate builders are preferred.

Inorganic, non-phosphate builders for use in the invention include hydroxides, carbonates, silicates, zeolites, and mixtures thereof.

Suitable hydroxide builders for use in the invention include sodium and potassium hydroxide.

Suitable carbonate builders for use in the invention include mixed or separate, anhydrous or partially hydrated alkali metal carbonates, bicarbonates or sesquicarbonates. Preferably the alkali metal is sodium and/or potassium, with sodium carbonate being particularly preferred.

Suitable silicate builders include amorphous forms and/or crystalline forms of alkali metal (such as sodium) silicates. Preferred are crystalline layered sodium silicates (phyllosilicates) of the general formula (I)

NaMSiₓO_{2x+1.}yH₂O (I)

in which M is sodium or hydrogen, x is a number from 1.9 to 4, preferably 2 or 3 and y is a number from 0 to 20. Sodium disilicates of the above formula in which M is sodium and x is 2 are particularly preferred. Such materials can be prepared with different crystal structures, referred to as α, β, γ and δ phases, with δ-sodium disilicate being most preferred.

Zeolites are naturally occurring or synthetic crystalline aluminosilicates composed of (SiO₄)⁴⁻and (AlO₄)⁵⁻tetrahedra, which share oxygen-bridging vertices and form cage-like structures in crystalline form. The ratio between oxygen, aluminium and silicon is O:(Al+Si)=2:1. The frameworks acquire their negative charge by substitution of some Si by Al. The negative charge is neutralised by cations and the frameworks are sufficiently open to contain, under normal conditions, mobile water molecules. Suitable zeolite builders for use in the invention may be defined by the general formula (II):Naₓ,[(AlO₂)ₓ(SiO₂)_{y}]·zH₂O (II) in which x and y are integers of at least 6, the molar ratio of x to y is in the range from about 1 to about 0.5, and z is an integer of at least 5, preferably from about 7.5 to about 276, more preferably from about 10 to about 264.

Preferred inorganic, non-phosphate builders for use in the invention may be selected from zeolites (of the general formula (II) defined above), sodium carbonate, δ-sodium disilicate and mixtures thereof.

Suitable organic, non-phosphate builders for use in the invention include polycarboxylates, in acid and/or salt form. When utilized in salt form, alkali metal (e.g. sodium and potassium) or alkanolammonium salts are preferred. Specific examples of such materials include sodium and potassium citrates, sodium and potassium tartrates, the sodium and potassium salts of tartaric acid monosuccinate, the sodium and potassium salts of tartaric acid disuccinate, sodium and potassium ethylenediaminetetraacetates, sodium and potassium N(2-hydroxyethyl)-ethylenediamine triacetates, sodium and potassium nitrilotriacetates and sodium and potassium N-(2-hydroxyethyl)-nitrilodiacetates. Polymeric polycarboxylates may also be used, such as polymers of unsaturated monocarboxylic acids (e.g. acrylic, methacrylic, vinylacetic, and crotonic acids) and/or unsaturated dicarboxylic acids (e.g. maleic, fumaric, itaconic, mesaconic and citraconic acids and their anhydrides). Specific examples of such materials include polyacrylic acid, polymaleic acid, and copolymers of acrylic and maleic acid. The polymers may be in acid, salt or partially neutralised form and may suitably have a molecular weight (Mw) ranging from about 1,000 to 100,000, preferably from about 2,000 to about 85,000, and more preferably from about 2,500 to about 75,000.

Preferred organic, non-phosphate builders for builders for use in the invention may be selected from polycarboxylates (e.g. citrates) in acid and/or salt form and mixtures thereof.

Mixtures of any of the above described materials may also be used.

Preferably the level of phosphate builders in a detergent composition of the invention is no more than 0.2%, preferably from 0 to 0.1%, more preferably from 0 to 0.01% and most preferably 0% (by weight based on the total weight of the composition). The term “phosphate builder” in the context of this invention denotes alkali metal, ammonium and alkanolammonium salts of polyphosphate, orthophosphate, and/or metaphosphate (e.g. sodium tripolyphosphate).

The overall level of builder, when included, may range from about 0.1 to about 80%, preferably from about 0.5 to about 50% (by weight based on the total weight of the composition).

Transition Metal Ion Sequestrants

In addition to the (EDDHA) and/or salts thereof (a) as described above, a detergent composition according to the invention may contain additional transition metal ion sequestrants such as phosphonate sequestrants, in acid form and/or in salt form (such as the alkali metal (e.g. sodium and potassium) or alkanolammonium salts). Specific examples of such materials include aminotris (methylene phosphonic acid) (ATMP), 1-hydroxyethylidene diphosphonic acid (HEDP) and diethylenetriamine penta (methylene phosphonic acid (DTPMP) and their respective sodium or potassium salts. Mixtures of any of the above described materials may also be used.

However, the level of such phosphonate sequestrants in a detergent composition of the invention is typically no more than 0.2%, preferably from 0 to 0.1%, more preferably from 0 to 0.01% and most preferably 0% (by weight based on the total weight of the composition).

A particulate detergent composition of the invention may include one or more fillers to assist in providing the desired density and bulk to the composition. Suitable fillers for use in the invention may generally be selected from neutral salts with a solubility in water of at least 1 gram per 100 grams of water at 20° C.; such as alkali metal, alkaline earth metal, ammonium or substituted ammonium chlorides, fluorides, acetates and sulfates and mixtures thereof. Preferred fillers for use in the invention include alkali metal (more preferably sodium and/or potassium) sulfates and chlorides and mixtures thereof, with sodium sulfate and/or sodium chloride being most preferred.

Filler, when included, may be present in a total amount ranging from about 1 to about 80%, preferably from about 5 to about 50% (by weight based on the total weight of the composition).

Polymeric Cleaning Boosters

A detergent composition according to the invention may include one or more polymeric cleaning boosters such as antiredeposition polymers, soil release polymers and mixtures thereof.

Anti-redeposition polymers stabilise the soil in the wash solution thus preventing redeposition of the soil. Suitable anti-redeposition polymers for use in the invention include alkoxylated polyethyleneimines. Polyethyleneimines are materials composed of ethylene imine units—CH₂CH₂NH— and, where branched, the hydrogen on the nitrogen is replaced by another chain of ethylene imine units. Preferred alkoxylated polyethylenimines for use in the invention have a polyethyleneimine backbone of about 300 to about 10000 weight average molecular weight (M_{w}). The polyethyleneimine backbone may be linear or branched. It may be branched to the extent that it is a dendrimer. The alkoxylation may typically be ethoxylation or propoxylation, or a mixture of both. Where a nitrogen atom is alkoxylated, a preferred average degree of alkoxylation is from 10 to 30, preferably from 15 to 25 alkoxy groups per modification. A preferred material is ethoxylated polyethyleneimine, with an average degree of ethoxylation being from 10 to 30, preferably from 15 to 25 ethoxy groups per ethoxylated nitrogen atom in the polyethyleneimine backbone.

Preferably, the polyamine is a soil release agent comprising a polyamine backbone corresponding to the formula:

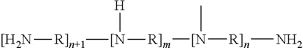

having a modified polyamine formula V(n+1)WmYnZ, or a polyamine backbone corresponding to the formula:

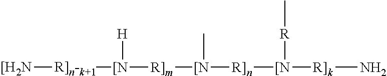

having a modified polyamine formula V(nk+1)WmYnY′kZ, wherein k is less than or equal to n,

Preferably, the polyamine backbone prior to modification has a molecular weight greater than about 200 daltons.

Preferably,

i) V units are terminal units having the formula:

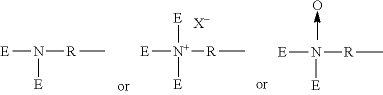

ii) W units are backbone units having the formula

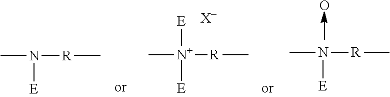

iii) Y units are branching units having the formula: and

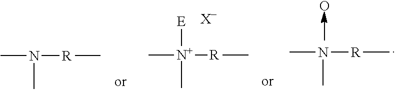

iv) Z units are terminal units having the formula:

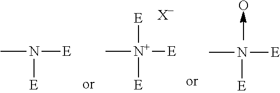

Preferably, backbone linking R units are selected from the group consisting of C2-C12 alkylene, —(R1O)xR3 (OR1)x-, —(CH₂CH(OR2)CH₂O)z(R1O)yR1(OCH₂CH(OR2)CH₂)w-, —CH₂CH(OR2)CH₂- and mixtures thereof,

provided that when R comprises C1-C12 alkylene R also comprises at least one—(R1O)xR3(OR1)x-, —(CH₂CH(OR2)CH₂O)z(R1O)yR1- (OCH₂CH(OR2)CH₂)w-, or —CH₂CH(OR2)CH₂-unit;

Preferably, R1 is C2-C6 alkylene and mixtures thereof;

Preferably, R2 is hydrogen, (R1O)XB, and mixtures thereof;

Preferably, R3 is C1-C12 alkylene, C3-C12 hydroxyalkylene, C4-C12 dihydroxy-alkylene, C8-C12 dialkylarylene, —C(O)—, —C(O)NHR5NHC(O)—, C(O)(R4)rC(O)—, —CH₂CH(OH)CH₂O(R1O)yR1O—CH₂CH(OH)CH₂—, and mixtures thereof;

Preferably, R4 is C1-C12 alkylene, C4-C12 alkenylene, C8-C12 arylalkylene, C6-C10 arylene, and mixtures thereof;

Preferably, R5 is C2-C12 alkylene or C6 C12 arylene;

Preferably, E units are selected from the group consisting of (CH₂)p-CO₂M, —(CH₂)qSO₃M, —CH(CH₂CO₂M)CO₂M, (CH₂)pPO₃M, —(R1O)xB, and mixtures thereof,

Preferably, B is hydrogen, —(CH₂)qSO₃M, —(CH₂)pCO₂M, —(CH₂)q CH(SO₃M)CH₂SO₃M, —(CH₂)qCH(SO₂M)CH₂SO₃M,—(CH2)pPO₃M, —PO₃M, and mixtures thereof,

Preferably, M is hydrogen or a water soluble cation in sufficient amount to satisfy charge balance;

Preferably X is a water soluble anion;

Preferably k has the value from 0 to about 20;

Preferably m has the value from 4 to about 400;

Preferably n has the value from 0 to about 200;

Preferably p has the value from 1 to 6,

Preferably q has the value from 0 to 6;

Preferably r has the value 0 or 1;

Preferably w has the value 0 or 1;

Preferably x has the value from 1 to 100;

Preferably y has the value from 0 to 100; and

Preferably z has the value 0 or 1.

The overall level of anti-redeposition polymer, when included, may range from 0.05 to 6%, more preferably from 0.1 to 5% (by weight based on the total weight of the composition).

More preferably, liquid compositions comprise from about 0.5% to about 4% polyamine, more preferably from 2.0 to 3.5% wt. of the composition.

Another type of suitable anti-redeposition polymer for use in the invention includes cellulose esters and ethers, for example sodium carboxymethyl cellulose.

Mixtures of any of the above described materials may also be used.

Soil release polymers help to improve the detachment of soils from fabric by modifying the fabric surface during washing. The adsorption of an SRP over the fabric surface is promoted by an affinity between the chemical structure of the SRP and the target fibre.

SRPs for use in the invention may include a variety of charged (e.g. anionic) as well as non-charged monomer units and structures may be linear, branched or star-shaped. The SRP structure may also include capping groups to control molecular weight or to alter polymer properties such as surface activity. The weight average molecular weight (M_{w}) of the SRP may suitably range from about 1000 to about 20,000 and preferably ranges from about 1500 to about 10,000.

SRPs for use in the invention may suitably be selected from copolyesters of dicarboxylic acids (for example adipic acid, phthalic acid or terephthalic acid), diols (for example ethylene glycol or propylene glycol) and polydiols (for example polyethylene glycol or polypropylene glycol). The copolyester may also include monomeric units substituted with anionic groups, such as for example sulfonated isophthaloyl units. Examples of such materials include oligomeric esters produced by transesterification/oligomerization of poly(ethyleneglycol) methyl ether, dimethyl terephthalate (“DMT”), propylene glycol (“PG”) and poly(ethyleneglycol) (“PEG”); partly- and fully-anionic-end-capped oligomeric esters such as oligomers from ethylene glycol (“EG”), PG, DMT and Na-3,6-dioxa-8-hydroxyoctanesulfonate; nonionic-capped block polyester oligomeric compounds such as those produced from DMT, Me-capped PEG and EG and/or PG, or a combination of DMT, EG and/or PG, Me-capped PEG and Na-dimethyl-5-sulfoisophthalate, and copolymeric blocks of ethylene terephthalate or propylene terephthalate with polyethylene oxide or polypropylene oxide terephthalate

Other types of SRP for use in the invention include cellulosic derivatives such as hydroxyether cellulosic polymers, C₁-C₄ alkylcelluloses and C₄ hydroxyalkyl celluloses; polymers with poly(vinyl ester) hydrophobic segments such as graft copolymers of poly(vinyl ester), for example C₁-C₆ vinyl esters (such as poly(vinyl acetate)) grafted onto polyalkylene oxide backbones; poly(vinyl caprolactam) and related co-polymers with monomers such as vinyl pyrrolidone and/or dimethylaminoethyl methacrylate; and polyester-polyamide polymers prepared by condensing adipic acid, caprolactam, and polyethylene glycol.

Preferred SRPs for use in the invention include copolyesters formed by condensation of terephthalic acid ester and diol, preferably 1,2 propanediol, and further comprising an end cap formed from repeat units of alkylene oxide capped with an alkyl group. Examples of such materials have a structure corresponding to general formula (II):

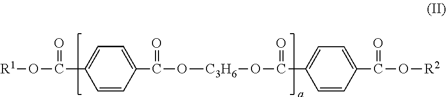

in which R¹ and R² independently of one another are X—(OC₂H₄)ₙ—(OC₃H₆)m, in which X is 01-4 alkyl and preferably methyl;

n is a number from 12 to 120, preferably from 40 to 50;

m is a number from 1 to 10, preferably from 1 to 7; and

a is a number from 4 to 9.

Because they are averages, m, n and a are not necessarily whole numbers for the polymer in bulk.

Mixtures of any of the above described materials may also be used.

The overall level of SRP, when included, may range from 0.1 to 10%, preferably from 0.3 to 7%, more preferably from 0.5 to 5% (by weight based on the total weight of the composition).

Fatty Acid

A detergent composition according to the invention may in some cases contain one or more fatty acids and/or salts thereof.

Suitable fatty acids in the context of this invention include aliphatic carboxylic acids of formula RCOOH, where R is a linear or branched alkyl or alkenyl chain containing from 6 to 24, more preferably 10 to 22, most preferably from 12 to 18 carbon atoms and 0 or 1 double bond. Preferred examples of such materials include saturated C12-18 fatty acids such as lauric acid, myristic acid, palmitic acid or stearic acid; and fatty acid mixtures in which 50 to 100% (by weight based on the total weight of the mixture) consists of saturated C12-18 fatty acids. Such mixtures may typically be derived from natural fats and/or optionally hydrogenated natural oils (such as coconut oil, palm kernel oil or tallow).

The fatty acids may be present in the form of their sodium, potassium or ammonium salts and/or in the form of soluble salts of organic bases, such as mono-, di- or triethanolamine.

Mixtures of any of the above described materials may also be used.

Fatty acids and/or their salts, when included, may be present in an amount ranging from about 0.25 to 5%, more preferably from 0.5 to 5%, most preferably from 0.75 to 4% (by weight based on the total weight of the composition).

For formula accounting purposes, in the formulation, fatty acids and/or their salts (as defined above) are not included in the level of surfactant or in the level of builder.

Rheology Modifiers

A liquid detergent composition according to the invention may comprise one or more rheology modifiers. Examples of such materials include polymeric thickeners and/or structurants such as hydrophobically modified alkali swellable emulsion (HASE) copolymers. Exemplary HASE copolymers for use in the invention include linear or crosslinked copolymers that are prepared by the addition polymerization of a monomer mixture including at least one acidic vinyl monomer, such as (meth)acrylic acid (i.e. methacrylic acid and/or acrylic acid); and at least one associative monomer. The term “associative monomer” in the context of this invention denotes a monomer having an ethylenically unsaturated section (for addition polymerization with the other monomers in the mixture) and a hydrophobic section. A preferred type of associative monomer includes a polyoxyalkylene section between the ethylenically unsaturated section and the hydrophobic section. Preferred HASE copolymers for use in the invention include linear or crosslinked copolymers that are prepared by the addition polymerization of (meth)acrylic acid with (i) at least one associative monomer selected from linear or branched C₈-C₄₀ alkyl (preferably linear C₁₂—C₂₂ alkyl) polyethoxylated (meth)acrylates; and (ii) at least one further monomer selected from C₁—C₄ alkyl (meth) acrylates, polyacidic vinyl monomers (such as maleic acid, maleic anhydride and/or salts thereof) and mixtures thereof. The polyethoxylated portion of the associative monomer (i) generally comprises about 5 to about 100, preferably about 10 to about 80, and more preferably about 15 to about 60 oxyethylene repeating units.

Mixtures of any of the above described materials may also be used.

Polymeric thickeners, when included, may be present in an amount ranging from 0.1 to 5% (by weight based on the total weight of the composition).

A liquid detergent composition according to the invention may also have its rheology modified by use of one or more external structurants which form a structuring network within the composition. Examples of such materials include hydrogenated castor oil, microfibrous cellulose and citrus pulp fibre. The presence of an external structurant may provide shear thinning rheology and may also enable materials such as encapsulates and visual cues to be suspended stably in the liquid.

Enzymes

A detergent composition according to the invention may comprise an effective amount of one or more enzymes selected from the group comprising, pectate lyase, protease, amylase, cellulase, lipase, mannanase and mixtures thereof. The enzymes are preferably present with corresponding enzyme stabilizers.

The level of each enzyme in the composition of the invention is from 0.0001 wt. % to 1 wt. % (of the composition). Total enzyme levels may be from 0.0001 to 5%.

Levels of enzyme present in the composition preferably relate to the level of enzyme as pure protein.

Preferred enzymes include those in the group consisting of: proteases, cellulases, alpha-amylases, peroxidases/oxidases, pectate lyases, and/or mannanases. Said preferred enzymes include a mixture of two or more of these enzymes.

Preferably the enzyme is selected from: proteases, cellulases, and/or alpha-amylases.

Preferred proteases are selected from the following group, serine, acidic, metallo- and cysteine proteases. More preferably the protease is a serine and/or acidic protease.

Preferably the protease is a serine protease. More preferably the serine protease is subtilisin type serine protease.

Protease enzymes hydrolyse bonds within peptides and proteins, in the cleaning context this leads to enhanced removal of protein or peptide containing stains. Serine proteases are preferred. Subtilase type serine proteases are more preferred. The term “subtilases” refers to a sub-group of serine protease according to Siezen et al., Protein Engng. 4 (1991) 719-737 and Siezen et al. Protein Science 6 (1997) 501-523. Serine proteases are a subgroup of proteases characterized by having a serine in the active site, which forms a covalent adduct with the substrate. The subtilases may be divided into 6 sub-divisions, i.e. the Subtilisin family, the Thermitase family, the Proteinase K family, the Lantibiotic peptidase family, the Kexin family and the Pyrolysin family.

Examples of subtilases are those derived from Bacillus species such as Bacillus lentus, B. licheniformis, B. alkalophilus, B. subtilis, B. amyloliquefaciens, B. pumilus and B. gibsonii described in; U.S. Pat. No. 7,262,042 and WO09/021867, and subtilisin lentus, subtilisin Novo, subtilisin Carlsberg, subtilisin BPN′, subtilisin 309, subtilisin 147 and subtilisin 168 described in WO 89/06279 and protease PD138 described in (WO 93/18140). Other useful proteases may be those described in WO 92/175177, WO 01/016285, WO 02/026024 and WO 02/016547. Examples of trypsin-like proteases are trypsin (e.g. of porcine or bovine origin) and the Fusarium protease described in WO 89/06270, WO 94/25583 and WO 05/040372, and the chymotrypsin proteases derived from Cellumonas described in WO 05/052161 and WO 05/052146.

Most preferably the protease is a subtilisin protease (EC 3.4.21.62).

Examples of subtilases are those derived from Bacillus such as Bacillus lentus, B. alkalophilus, B. subtilis, B. amyloliquefaciens, B. pumilus and B. gibsonii described in; U.S. Pat. No. 7,262,042 and WO09/021867, and subtilisin lentus, subtilisin Novo, subtilisin Carlsberg, Bacillus licheniformis, subtilisin BPN′, subtilisin 309, subtilisin 147 and subtilisin 168 described in WO89/06279 and protease PD138 described in (WO93/18140). Preferably the subsilisin is derived from Bacillus, preferably B. lentus, B. alkalophilus, B. subtilis, B. amyloliquefaciens, B. pumilus and Bacillus gibsonii as described in U.S. Pat. No. 6,312,936 BI, U.S. Pat. Nos. 5,679,630, 4,760,025, 7,262,042 and WO 09/021867. Most preferably the subtilisin is derived from B. gibsonii or B. Lentus.

Suitable commercially available protease enzymes include those sold under the trade names names Carnival®, Relase®, Relase® Ultra, Savinase®, Savinase® Ultra, Coronase®, Coronase® Ultra, Kannase®, Liquanase®, Liquanase® Ultra, all could be sold as Ultra® or Evity® (Novozymes A/S).

The invention may be carried out in the presence of phospholipase classified as EC 3.1.1.4 and/or EC 3.1.1.32. As used herein, the term phospholipase is an enzyme which has activity towards phospholipids.

Phospholipids, such as lecithin or phosphatidylcholine, consist of glycerol esterified with two fatty acids in an outer (sn-1) and the middle (sn-2) positions and esterified with phosphoric acid in the third position; the phosphoric acid, in turn, may be esterified to an amino-alcohol. Phospholipases are enzymes which participate in the hydrolysis of phospholipids. Several types of phospholipase activity can be distinguished, including phospholipases A₁ and A₂ which hydrolyze one fatty acyl group (in the sn-1 and sn-2 position, respectively) to form lysophospholipid; and lysophospholipase (or phospholipase B) which can hydrolyze the remaining fatty acyl group in lysophospholipid. Phospholipase C and phospholipase D (phosphodiesterases) release diacyl glycerol or phosphatidic acid respectively.

The composition may use cutinase, classified in EC 3.1.1.74. The cutinase used according to the invention may be of any origin. Preferably cutinases are of microbial origin, in particular of bacterial, of fungal or of yeast origin.

Suitable amylases (alpha and/or beta) include those of bacterial or fungal origin. Chemically modified or protein engineered mutants are included. Amylases include, for example, alpha-amylases obtained from Bacillus, e.g. a special strain of B. licheniformis, described in more detail in GB 1,296,839, or the Bacillus sp. strains disclosed in WO 95/026397 or WO 00/060060. Commercially available amylases are Duramyl™, Termamyl™, Termamyl Ultra™, Natalase™, Stainzyme™, Amplify™, Fungamyl™ and BAN™ (Novozymes A/S), Rapidase™ and Purastar™ (from Genencor International Inc.).

Suitable cellulases include those of bacterial or fungal origin. Chemically modified or protein engineered mutants are included. Suitable cellulases include cellulases from the genera Bacillus, Pseudomonas, Humicola, Fusarium, Thielavia, Acremonium, e.g. the fungal cellulases produced from Humicola insolens, Thielavia terrestris, Myceliophthora thermophila, and Fusarium oxysporum disclosed in U.S. Pat. Nos. 4,435,307, 5,648,263, 5,691,178, 5,776,757, WO 89/09259, WO 96/029397, and WO 98/012307. Commercially available cellulases include Celluzyme™, Carezyme™, Celluclean™ Endolase™, Renozyme™ (Novozymes A/S), Clazinase™ and Puradax HA™ (Genencor International Inc.), and KAC-500(B)™ (Kao Corporation). Celluclean™ is preferred.

Suitable peroxidases/oxidases include those of plant, bacterial or fungal origin. Chemically modified or protein engineered mutants are included. Examples of useful peroxidases include peroxidases from Coprinus, e.g. from C. cinereus, and variants thereof as those described in WO 93/24618, WO 95/10602, and WO 98/15257. Commercially available peroxidases include Guardzyme™ and Novozym™ 51004 (Novozymes A/S).

Further enzymes suitable for use are discussed in WO 2009/087524, WO 2009/090576, WO 2009/107091, WO 2009/111258 and WO 2009/148983.

Enzyme Stabilizers

Any enzyme present in the composition may be stabilized using conventional stabilizing agents, e.g., a polyol such as propylene glycol or glycerol, a sugar or sugar alcohol, lactic acid, boric acid, or a boric acid derivative, e.g., an aromatic borate ester, or a phenyl boronic acid derivative such as 4-formylphenyl boronic acid, and the composition may be formulated as described in e.g. WO 92/19709 and WO 92/19708.

A liquid detergent composition according to the invention preferably has a pH in the range of 5 to 9, more preferably 6 to 8, when measured on dilution of the composition to 1% (by weight based on the total weight of the composition) using demineralised water.

Other Ingredients

A detergent composition of the invention may contain further optional ingredients to enhance performance and/or consumer acceptability. Examples of such ingredients include fragrance oils, foam boosting agents, preservatives (e.g. bactericides), antioxidants, sunscreens, anticorrosion agents, colorants, pearlisers and/or opacifiers, and shading dye. Each of these ingredients will be present in an amount effective to accomplish its purpose. Generally, these optional ingredients are included individually at an amount of up to 5% (by weight based on the total weight of the composition).

A detergent composition of the invention generally contains no more than 0.2%, preferably from 0 to 0.1%, more preferably from 0 to 0.01% and most preferably 0% (by weight based on the total weight of the composition) of transition metal ions selected from Fe Op, Co (II), Co (III), Mn (II); Mn (III), Ce (III); Ce (IV), Zn (II) and Bi (III) and mixtures thereof.

A detergent composition of the invention generally contains no more than 0.2%, preferably no more than 0.1%, more preferably no more than 0.01% and most preferably 0% (by weight based on the total weight of the composition) of oxidising agents selected from halogen-based bleaches (e.g. alkali metal hypochlorites and alkali metal salts of di- and tri-chloro and di- and tri-bromo cyanuric acids), oxygen-based bleaches (e.g. sodium perborate (tetra-or monohydrate), sodium percarbonate and hydrogen peroxide) and mixtures thereof.

Packaging and Dosing

The detergent composition of the invention may be packaged as unit doses in polymeric film soluble in the wash water. Alternatively, the detergent composition of the invention may be supplied in multidose plastics packs with a top or bottom closure. A dosing measure may be supplied with the pack either as a part of the cap or as an integrated system.

A method for the non-oxidative laundering of fabric stains using a detergent composition according to the invention comprises diluting a dose of the detergent composition to obtain a wash liquor and washing the stained fabric with the wash liquor so formed.

The method may suitably be carried out in a top-loading or front-loading automatic washing machine or can be carried out by hand.

In automatic washing machines, the dose of detergent composition is typically put into a dispenser and from there it is flushed into the machine by the water flowing into the machine, thereby forming the wash liquor. Dosages for a typical front-loading washing machine (using 10 to 15 litres of water to form the wash liquor) may range from about 10 ml to about 100 ml, preferably about 15 to 75 ml. Dosages for a typical top-loading washing machine (using from 40 to 60 litres of water to form the wash liquor) may be higher, e.g. 100 ml or more. Lower dosages of detergent (e.g. 50 ml or less) may be used for hand washing methods (using about 1 to 10 litres of water to form the wash liquor).

A subsequent aqueous rinse step and drying the laundry is preferred. Any input of water during any optional rinsing step(s) is not included when determining the volume of the wash liquor. Laundry drying can take place either in an automatic dryer or in the open air.

The invention will now be further described with reference to the following non-limiting Examples.

### EXAMPLES

All weight percentages are by weight based on total weight unless otherwise specified. Compositions according to the invention are indicated by a number; and comparative examples (not according to the invention) are indicated by a letter.

Exemplary formulations are

| Ingredient | wt % (active ingredient) |
|---|---|
| Glycerol | 2.0 |
| Alcohol ethoxylate | 4.3 |
| LAS acid | 5.8 |
| TEA | 8.8 |
| Lauric acid | 0.9 |
| SLES 1 EO | 4.4 |
| EPEI (Sokalan ® HP20) | 3.1 |
| SRP ( Texcare ® SRN UL50) | 1.0 |
| Mannanase nzymes: e.g. Mannaway ® | 1.2 |
| Pectate lyase enzymes: e.g. Xpect 1000 L ® | 0.4 |
| Protease enzymes: e.g. Alcalase ™, Relase | 1.0 |
| Evity ™ 16 L, Savinase ™. | |
| Lipase Enzymes: e.g. Lipex ™ L | 1.0 |
| Preservative | 0.03 |
| Water | q.s. to 100 |

Comparison of Tea Stain Removal by EDDHA, MGDA and Citric Acid

In a series of tests on tea stained cotton, the stain removal performance of EDDHA was compared against two other phosphorus-free metal sequestrants used at the same molar concentration: MGDA (sourced as a 40% w/w aqueous solution of the trisodium salt) and citric acid (sourced as >99.5% pure material). EDDHA was supplied as a>98% purity solid by Nouryon and used as received.

Stain removal performance was compared in the presence of different wash water conditions to mimic variations in global water quality.

Model wash waters were prepared by doping demineralized water with ppm levels of hardness or transition metal ions, as follows:

Hard model wash water (a) was prepared by dissolving 0.588 g calcium chloride dihydrate and 0.408 g magnesium chloride hexahydrate into 1 litre of demineralized water.to give 60° FH hardness and a 2:1 calcium to magnesium ratio.

Transition metal doped model wash water (b) was prepared by first dissolving 5.18 g of ammonium iron (III) sulfate dodecahydrate, 1.298 g of copper (II) sulfate pentahydrate, 3.034 g of zinc sulfate heptahydrate and 0.111 g manganese sulfate monohydrate in 0.5 litres of demineralized water, then acidifying the solution to pH 1.0 by dropwise addition of concentrated sulfuric acid. 0.625 ml of the acidified solution so produced (hereinafter termed “acidified TM concentrate”) was then added to 300 ml of demineralised water, immediately prior to use.

A laundry liquid detergent base was prepared by sequential mixing of the ingredients as shown in Table 1.

TABLE 1

| Ingredient | wt % (active ingredient) |
|---|---|
| Glycerol | 2.0 |
| Alcohol ethoxylate | 4.3 |
| LAS acid | 5.8 |
| TEA | 8.8 |
| Lauric acid | 0.9 |
| SLES 1 EO | 4.4 |
| Preservative | 0.03 |
| Water | q.s. to 100 |

Test wash liquors were prepared immediately before use by combining, in a test vial, 4 ml of either hard model wash water (a) or transition metal doped model wash water (b); 2 ml of detergent solution prepared by dissolving 14.5 g of the Table 1 formulation in 1 litre of demineralized water; and 4 ml of sequestrant solution prepared by dissolving either DFOM, MGDA or citric acid in demineralized water to form a 0.5 mM solution.

Sequestrant free control wash liquors were also prepared by substituting demineralized water for the sequestrant solution. The total volume of test wash liquor in each test vial was 10 ml.

The pH values of the test wash liquors were measured using a pH meter and found to all be in the range 7.7+/−0.1 units.

The sequestrants and model wash waters used in generating each of the test wash liquors are given in Table 2.

TABLE 2

| Test wash | Sequestrant used in test | Model wash water used |
|---|---|---|
| liquor | wash liquor | in test wash liquor |
| A | None | Hard (a) |
| 1 | EDDHA | Hard (a) |
| B | MGDA | Hard (a) |
| C | Citric acid | Hard (a) |
| D | None | Transition metal doped (b) |
| 2 | EDDHA | Transition metal doped (b) |
| E | MGDA | Transition metal doped (b) |
| F | Citric acid | Transition metal doped (b) |

0.2 g swatches of tea stained cotton textile were added to each test wash liquor in its respective test vial. The test vials were then sealed, placed in a REAX end-over end mixer and agitated on a setting of 4 for 30 minutes at ambient temperature (20.0+/−0.6° C.) to mimic a main wash condition. The test wash liquor was then drained out of each test vial and replaced with 10 ml of fresh model wash water (of the same type as used to prepare the selected test wash liquor). The test vials were recapped and returned to the mixer for 5 minutes to mimic a rinsing step. The swatches were then removed from the test vials and allowed to air dry on a paper towel at ambient temperature in the open laboratory, before making reflectance measurements.

The extent of tea stain removal was measured by making diffuse reflectance measurements using an X-Rite Color i7 spectrometer fitted with the Medium Area View port (0.1 cm diameter). The sampling mode was set to Reflectance—specular included. The spectrometer was standardised using a two-point calibration with the white tile and light trap supplied with the instrument using unstained cotton as a control. Data were exported as the CIE L*, a* and b* values. Three replicate swatches were measured for each combination of sequestrant and metal ion solution.

The extent of stain removal is calculated as the Stain Removal Index (SRI), defined as:

SRI=100− ΔE, where ΔE is the difference in colour of the stained cloth compared to an unstained cloth.

The results are shown in Table 3.

TABLE 3

| Test wash liquor | SRI (mean +/− standard deviation) |
|---|---|
| A | 75.9 +/− 0.3 |
| 1 | 81.3 +/− 0.3 |
| B | 78.0 +/− 0.2 |
| C | 77.3 +/− 0.3 |
| D | 80.3 +/− 0.2 |
| 2 | 85.8 +/− 0.2 |
| E | 82.0 +/− 0.3 |
| F | 80.8 +/− 0.3 |

These results show that the wash liquors according to the invention (Examples 1 and 2) outperform the wash liquors with an equimolar amount of MGDA (Examples B and E) and the wash liquors with an equimolar amount of citric acid (Examples C and F) on tea stained cotton.

Comparison of Polyphenol Stain Removal by EDDHA, HEDP and DTPMP

The polyphenol stain removal performance of EDDHA in a laundry liquid detergent was assessed and compared with two phosphonate sequestrants, 1-hydroxy-ethylidenediphosphonic acid (HEDP) and diethylene triamine penta methylene phosphonic acid), DTPMP.

A detergent base was prepared but omitting 5% of the water content to provide a “hole” suitable for replacement by the sequestrant.

A pH neutral 20% w/w stock solution of EDDHA sodium salt was prepared by dropwise addition of 1.0M sodium hydroxide solution to a slurry of EDDHA acid in water. HEDP under the trade name Dequest® 2010 (60% w/w aqueous solution) was supplied by Italmatch S.p.a and used as supplied. DTPMP heptasodium salt under the trade name Dequest® 2066 was supplied as a 32% solution by Italmatch.

These sequestrants were incorporated into the laundry liquid detergent base to give the compositions listed in Table 4. HEDP and DTPMP were dosed at fixed inclusion levels of 1.0% and 0.75% respectively. EDDHA was dosed at a range of concentrations up to a maximum level of up to 2% w/w. A laundry liquid detergent base omitting any sequesterant (i.e. by filling the “hole” with water) was also prepared.

The formulations were allowed to stir overnight and then stored at ambient temperature. The formulations were physically stable over periods of up to 1 month at ambient temperature.

TABLE 4

| Ingredient | wt % (active ingredient) | | | | | |
|---|---|---|---|---|---|---|
| Formulation | Ex. G | Ex. 3 | Ex. 4 | Ex. 5 | Ex. H | Ex. I |
| Glycerol | 2.0 | 2.0 | 2.0 | 2.0 | 2.0 | 2.0 |
| Alcohol | 4.3 | 4.3 | 4.3 | 4.3 | 4.3 | 4.3 |
| ethoxylate | | | | | | |
| LAS acid | 5.8 | 5.8 | 5.8 | 5.8 | 5.8 | 5.8 |
| TEA | 8.8 | 8.8 | 8.8 | 8.8 | 8.8 | 8.8 |
| Lauric acid | 0.9 | 0.9 | 0.9 | 0.9 | 0.9 | 0.9 |
| SLES 1 EO | 4.4 | 4.4 | 4.4 | 4.4 | 4.4 | 4.4 |
| Preservative | 0.03 | 0.03 | 0.03 | 0.03 | 0.03 | 0.03 |
| EDDHA | 0 | 0.5 | 1.0 | 2.0 | 0 | 0 |
| HEDP | 0 | 0 | 0 | 0 | 1.0 | 0 |
| DTPMP | 0 | 0 | 0 | 0 | 0 | 0.75 |

| | |
|---|---|
| Water | q.s. to 100 |

The pH values of the formulations were measured using a pH meter and found to all be in the range 7.6+/−0.1 units.

The formulations were evaluated for their cleaning performance at 30° C. using a Heraeus 12-pot Linitester to mimic the mechanical action of a front-loading automatic washing machine.

Model wash waters were prepared by doping demineralized water with ppm levels of hardness and/or transition metal ions, as follows:

Hard model wash water (c) was prepared by dissolving 0.235 g calcium chloride dihydrate and 0.163 g magnesium chloride hexahydrate into 1 litre of demineralised water to give 24° FH hardness and a 2:1 calcium to magnesium ratio.

Transition metal doped model wash water (d) was prepared by adding 2.5 ml of acidified TM concentrate (as described above) to 3 litres of demineralised water, immediately prior to use.

Transition metal doped hard model wash water (e) was prepared by adding 2.5 ml of acidified TM concentrate to 3 litres of the 24° FH hard model wash water (c).

Test wash liquors were prepared by diluting 2.9 g of the selected test formulation (Example G, H, I, 3, 4 or 5 respectively) in 1 litre of model wash water (model wash water

(c), (d) or (e) respectively).

A 100 ml aliquot of the selected test wash liquor was dosed in a Linitest pot. 2.0 cm×2.0 cm swatches of tea and wine stained cotton and 20 cm×20 cm swatches of unstained cotton ballast were placed into each Linitest pot. The pots were sealed and attached to the Linitester cradle and rotated at 40 rpm for 30 minutes at 30° C. to simulate a main wash in a front-loader washing machine.

The swatches were then removed from the pots and wrung out by hand to drain residual test wash liquor. The Linitest pots were rinsed and 100 ml of model wash water (of the same type as used to prepare the selected test wash liquor) was added. The swatches were returned to the pots and rinsed for 5 minutes. The swatches were then removed, wrung out and the rinse water drained and replaced with fresh model wash water (of the same type as used to prepare the selected test wash liquor) before returning the swatches to the pot and carrying out a second 5-minute rinse. The swatches were placed on laboratory paper towel and allowed to air dry in the open laboratory.

Eight replicate swatches were used for each system. SRI measurements were made using the protocol described above.

The results are shown in Tables 5 and 6.

TABLE 5
Tea stain removal

| Model wash water used | Formulation used in test wash liquor | | |
|---|---|---|---|
| in test wash liquor | Example G | Example 3 | Example 4 |
| Hard (c) | 81.5 +/− 1.0 | 83.4 +/− 0.7 | 84.6 +/− 0.5 |
| Transition metal doped (d) | 84.9 +/− 0.5 | 86.5 +/− 0.3 | 87.2 +/− 0.2 |
| Hard, transition metal doped (e) | 79.9 +/− 0.6 | 82.3 +/− 0.1 | 83.4 +/− 0.6 |

Wine stain removal

| Model wash water used | Formulation used in test wash liquor | | |
|---|---|---|---|
| in test wash liquor | Example G | Example 3 | Example 4 |
| Hard (c) | 89.7 +/− 0.5 | 92.0 +/− 0.8 | 92.1 +/− 0.4 |
| Transition metal doped (d) | 91.4 +/− 0.1 | 92.5 +/− 0.2 | 93.2 +/− 0.3 |
| Hard, transition metal doped (e) | 87.4 +/− 0.1 | 89.1 +/− 0.4 | 90.5 +/− 0.5 |

TABLE 6
Tea stain removal

| Model wash water used | Formulation used in test wash liquor | | |
|---|---|---|---|
| in test wash liquor | Example 5 | Example H | Example I |
| Hard (c) | 84.0 +/− 0.9 | 87.4 +/− 0.3 | 83.2 +/− 0.5 |
| Transition metal doped (d) | 87.1 +/− 0.3 | 87.8 +/− 0.7 | 86.0 +/− 0.3 |
| Hard, transition metal doped | 84.2 +/− 0.3 | 86.4 +/− 1.5 | 81.8 +/− 0.2 |
| (e) | | | |

Wine stain removal

| Model wash water used | Formulation used in test wash liquor | |
|---|---|---|
| in test wash liquor | Example 5 | Example H |
| Hard (c) | 92.8 +/− 0.1 | 92.6 +/− 0.1 |
| Transition metal doped (d) | 93.4 +/− 0.1 | 93.2 +/− 0.1 |
| Hard, transition metal doped | 91.8 +/− 0.5 | 91.9 +/− 0.3 |
| (e) | | |

The results show that Examples 3 to 5 according to the invention provide significantly improved stain removal relative to the sequestrant-free control (Example G) under all water quality conditions and at inclusion levels as low as 0.5% w/w (Example 3). For wine stain removal, Example 5 provides equivalent performance to comparative Example H (which uses a phosphonate sequestrant) under all water quality conditions as does Example 4 in the presence of hardness ions or transition metal ions (without hardness ions). Example 3 matches the performance of comparative Example I (which uses a phosphonate sequestrant) for wine stain removal.

1. A detergent composition for the non-oxidative laundering of fabric stains, the composition comprising:
(a) from 0.1 to 4% (by weight based on the total weight of the composition) of ethylenediamine-N,N′-bis-(2-hydroxyphenyl) acetic acid (EDDHA) and/or salts thereof, and
(b) from 3 to 80% (by weight based on the total weight of the composition) of one or more detersive surfactants and further comprising one or more polymeric cleaning boosters.

2. A composition according to claim 1, wherein the one or more polymeric cleaning booster comprises an anti-redeposition polymer.

3. A composition according to claim 2, wherein anti-redeposition polymer includes a an alkoxylated polyethyleneimine.

4. A composition according to claim 1, wherein the polymeric cleaning booster comprises a soil release polymer.

5. A composition according to claim 1, wherein the composition further comprises an enzyme.

6. A composition according to claim 1, in which the EDDHA is in the sodium salt form.

7. A composition according to claim 1, in which the total amount of (a) ranges from 0.5 to 2.5% (by weight based on the total weight of the composition).

8. A composition according to claim 1, which the one or more detersive surfactants (b) are selected from non-soap anionic surfactants, nonionic surfactants and mixtures thereof.

9. A composition according to claim 1, in which the level of phosphonate sequestrants is no more than 0.2%, preferably from 0 to 0.1%, more preferably from 0 to 0.01% and most preferably 0% (by weight based on the total weight of the composition).

10. A composition according to claim 1, wherein the composition has a pH in the range of 6 to 8, when measured on dilution of the composition to 1% (by weight based on the total weight of the composition) using demineralised water.

11. A composition according to claim 1, which contains no more than 0.2%, (by weight based on the total weight of the composition) of transition metal ions selected from the group consisting of Fe (III), Co (II), Co (III), Mn (II), Mn (HI), Ce (III), Ce (IV), Zn (II) and Bi (III) and mixtures thereof.

12. A composition according to claim 1, which contains no more than 0.2%, (by weight based on the total weight of the composition) of oxidising agents selected from the group consisting of halogen-based bleaches (e.g. alkali metal hypochlorites and alkali metal salts of di- and tri-chloro and di-and tri-bromo cyanuric acids), oxygen-based bleaches (e.g. sodium perborate (tetra-or monohydrate), sodium percarbonate and hydrogen peroxide) and mixtures thereof.

13. A method for the non-oxidative laundering of fabric stains, comprising diluting a dose of the detergent composition as defined in claim 1 to obtain a wash liquor, and washing the stained fabric with the wash liquor so formed.
